(19) United States
(12) Patent Application Publication
(10) Pub. No.: US 2014/0285093 A1
(43) Pub. Date: Sep. 25, 2014

(54) Lighting Control System and Lighting Control Method

(71) Applicant: Toshiba Lighting & Technology Corporation, Yokosuka-shi (JP)

(72) Inventor: Yasushi Morimoto, Yokosuka-shi (JP)

(73) Assignee: Toshiba Lighting & Technology Corporation, Yokosuka-shi (JP)

(21) Appl. No.: 14/014,527

(22) Filed: Aug. 30, 2013

(30) Foreign Application Priority Data
Mar. 25, 2013 (JP) 2013-062695

(51) Int. Cl. H05B 37/02

(52) U.S. Cl. CPC H05B 37/02
USPC 315/152; 315/149

(57) ABSTRACT

According to one embodiment, a lighting control system includes a camera unit which pick up an image of a region which is illuminated by a lighting fixture, and outputs image data, and a control device. The control device performs a dimming control of a lighting fixture so that brightness in a region becomes a set value based on corrected illuminance obtained by performing a correction of illuminance of an influenced region which is influenced by illumination from another lighting fixture in the image data according to a dimming state of the other lighting fixture than the lighting fixture, and illuminance of an uninfluenced region which is not influenced by illumination from the other lighting fixture in the image data.

### CROSS-REFERENCE TO RELATED APPLICATION

This application is based upon and claims the benefit of priority from the Japanese Patent Application No. 2013-62695, filed on Mar. 25, 2013; the entire contents of which are incorporated herein by reference.

### FIELD

Embodiments described herein relate generally to a lighting control system and a lighting control method.

### BACKGROUND

In the related art, a lighting control system is widely used in order to control illumination in a building or the like. As the lighting control system, there is a system, for example, in which one, or two or more lighting fixtures are subject to a dimming control so that a room has desired brightness according to illuminance in the room.

For example, when each lighting fixture is subject to a dimming control so that a room has set brightness, illuminance in a region to be illuminated is detected using an illuminance sensor, a control device generates a dimming signal based on detected illuminance, and outputs the signal to each lighting fixture.

When a region to be illuminated is one, and illuminance in the region is detected using an illuminance sensor, a control device can perform a dimming control of each lighting fixture so that the region has set brightness.

In addition, even when there are a plurality of regions to be illuminated, and each of the regions is controlled so as to have respectively set brightness, the control device can perform a dimming control of each lighting fixture so that each region has set brightness, when each region does not include a region which is influenced by illumination from a neighboring region.

However, when each region includes a region which is influenced by illumination from a neighboring region, there is a problem when performing a dimming control so that each region has the set brightness.

First, since an illuminance sensor also detects illuminance in another neighboring region, not only detecting illuminance in the one region, when the illuminance sensor is used, the control device is not capable of individually detecting respective illuminance in the plurality of regions. For this reason, in order to control the respective plurality of regions to have the set brightness, a method should be adopted in which an illuminance sensor for detecting only one region is provided, and each lighting fixture is provided so that illumination light from a neighboring region does not come into each region or the like.

In addition, a method in which a camera is used, and illuminance of a region to be illuminated is calculated from image data from the camera is also suggested; however, when a region to be illuminated with desired brightness includes a region which is influenced by illumination light from a neighboring region, it is not possible to appropriately perform a dimming control with respect to a region to be illuminated.

### BRIEF DESCRIPTION OF THE DRAWINGS

FIG. 1 is a configuration diagram of a lighting control system according to one embodiment.

FIG. 2 is a plan view which illustrates an illumination range of a floor which is illuminated by a plurality of lighting fixtures according to the embodiment which are provided on a ceiling in a building.

FIG. 3 is a flowchart which illustrates a processing flow of a dimming control program according to the embodiment.

FIG. 4 is a diagram which illustrates an example of a coefficient table corresponding to a dimming level in a region A as a neighboring region of a region B, and for correcting illuminance, according to the embodiment.

FIG. 5 is a diagram which describes a configuration of a grid lighting system according to the embodiment.

### DETAILED DESCRIPTION

In general, according to one embodiment, a lighting control system includes a data output unit which outputs data including information on brightness in a region to be illuminated by a lighting fixture, and a control device which performs a dimming control of the lighting fixture so that brightness in a region becomes a set value based on a corrected first detection value obtained by performing a correction of a first detection value of brightness in an influenced region which is influenced by illumination from another lighting fixture in the region according to a dimming state of the other lighting fixture than the lighting fixture, and a second detection value of brightness in an uninfluenced region which is not influenced by illumination from the other lighting fixture in the region.

### Configuration

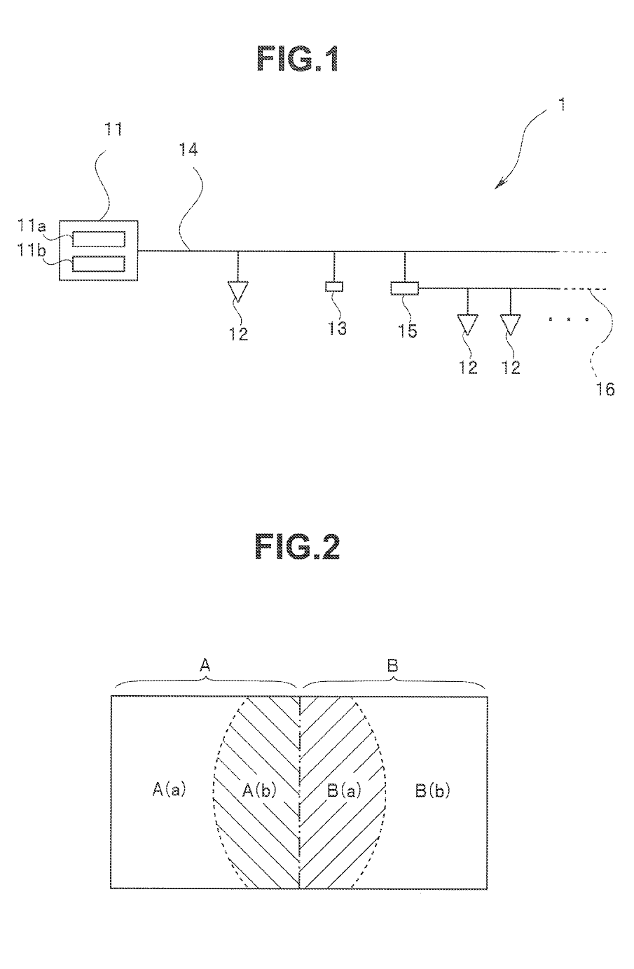

FIG. 1 is a configuration diagram of a lighting control system according to the embodiment. A lighting control system 1 is configured by including a control device 11 as a center device, a plurality of lighting fixtures 12, and a camera unit 13. The control device 11, the plurality of lighting fixtures 12, and the camera unit 13 are connected to each other through a signal transmission line 14.

Each lighting fixture 12 receives dimming data from the control device 11 through the signal transmission line 14. The camera unit 13 transmits image data to the control device 11 through the signal transmission line 14.

The control device 11 includes a central processing unit (hereinafter, referred to as CPU) 11a, and a storage unit 11b including a ROM, a RAM, and the like. In the control device 11, each function of the lighting control system 1 is realized when the CPU 11a reads out a dimming control program which is stored in the ROM, develops the program on the RAM, and executes the program. As will be described later, the control device 11 outputs dimming data for controlling the plurality of lighting fixtures 12 by receiving image data from the camera unit 13.

The control device 11 further includes input units (not shown) such as a keyboard, a mouse, and the like, and a monitor (not shown) which displays a control screen for performing a lighting control.

Each lighting fixture 12 is a lighting device in which, for example, a light emitting diode (hereinafter, referred to as LED) as a light emitting unit is used, and the lighting fixture emits illumination light by controlling an amount of light emitted by the light emitting unit based on received dimming data.

The lighting control system 1 is configured such that a part of the plurality of lighting fixtures 12 is directly connected to the signal transmission line 14, and receives dimming data, and a part of other lighting fixtures receives dimming data through a signal transmission line 16 of a terminal controller 15 which is connected to the signal transmission line 14.

Here, a case in which a dimming control of the plurality of lighting fixtures 12 is performed so that two regions A and B are illuminated by the plurality of lighting fixtures 12, and each region A and B have brightness which are respectively set thereto will be described.

The camera unit 13 is a CMOS sensor, has an object optical system, and is an area sensor which pick up an image of a two-dimensional region including the two regions A and B. That is, the camera unit 13 is an area sensor which outputs image data by pick up images of the regions A and B which are illuminated by the plurality of lighting fixtures 12. The camera unit 13 transmits the image data to the control device 11 through the signal transmission line 14.

The control device 11 cuts out image data in each region of the regions A and B from the received image data, extracts image data in an influenced region and an uninfluenced region which will be described later, and are set in each region, and calculates illuminance of each partial region from a luminance value of pixels of an image in each partial region. That is, the image data is data including information on brightness in the regions A and B which are illuminated by the plurality of lighting fixtures 12.

In addition, here, the camera unit 13 transmits the image data to the control device 11; however, the pieces of information on the brightness in each of regions A and B which are calculated from the image data in the area sensor may be transmitted to the control device 11 in order to prevent an increase in a traffic amount of the signal transmission line 14. That is, it may be configured such that a unit for inputting the image data which is output by the camera unit 13 is provided, the unit includes information on an influenced region and an uninfluenced region in the image data of the camera unit 13, the pieces of information on the brightness in the regions A and B are calculated from the image data based on pieces of information on the influenced region and the uninfluenced region, and the calculated pieces of information on the brightness are transmitted to the control device 11 through the signal transmission line. The unit configures a data output unit which outputs data including information on brightness in a region which is illuminated by a lighting fixture.

The control device 11 performs a dimming control of each lighting fixture 12 so that each of the regions has the set brightness by generating dimming data with respect to one, or two or more lighting fixtures 12 for each region based on illuminance in the influenced region and illuminance in the uninfluenced region in each of regions A and B, and by transmitting the data to each of the lighting fixtures 12.

FIG. 2 is a plan view which illustrates an illumination range of a floor which is illuminated by the plurality of lighting fixtures 12 which are provided on a ceiling in a building. The plurality of lighting fixtures 12 are provided in a building so that the region A is illuminated by a part of the plurality of lighting fixtures 12 of the lighting control system 1, and the region B is illuminated by another part of the plurality of lighting fixtures 12.

The camera unit 13 transmits image data of a region including the two regions A and B to the control device 11. As will be described below, the control device 11 obtains respective illuminance of the regions A and B from a luminance value of pixels in each of the regions A and B using a calculation, from the received image data.

First, in each illumination region, an influenced region which is influenced by illumination due to a lighting fixture which illuminates a neighboring illumination region, and an uninfluenced region which is not influenced by illumination due to a lighting fixture which illuminates a neighboring illumination region are preset with respect to each region of image data.

For example, in FIG. 2, in the region B, a region B (a) (portion denoted by slant lines which are surrounded with dotted line and two-dot chain line) which is close to the region A is an influenced region which is influenced by illumination in the region A. Accordingly, the region B (a) is an overlapped light distribution range in which a light distribution from a lighting fixture 12 which illuminates the neighboring region A is overlapped therewith. In addition, in the region B, a region B (b) which is far from the region A is an uninfluenced region which is not influenced by illumination in the region A.

Such an influenced region B (a) and an uninfluenced region B (b) in the region B may be set based on a light distribution state in a lighting setup design, or, the partial regions may be set using a measuring result which is obtained by measuring an influenced range of illumination in the region A in practice, by turning on a lighting fixture in the neighboring region A.

In the region A, as well, an influenced region A (b) and an uninfluenced region A (a) are similarly set, the region A (b) (portion denoted by slant lines surrounded with dotted line and two-dot chain line) which is close to the region B is the influenced region which is influenced by illumination in the region B, and the region A (a) which is far from the region B is the uninfluenced region which is not influenced by illumination in the region B. Accordingly, the region A (b) is an overlapped light distribution range in which a light distribution from a lighting fixture 12 which illuminates the neighboring region B is overlapped.

The storage unit 11b stores region setting data in advance which denotes regions or ranges of the influenced region A (b), the uninfluenced region A (a), the influenced region B (a), and the uninfluenced region B (b) in the image data which are preset with respect to the image data. That is, the region setting data which sets each influenced region and each uninfluenced region in the image data is preset in the storage unit 11b.

The control device 11 extracts each influenced region and each uninfluenced region from the image data based on the region setting data. Specifically, the control device 11 classifies the image data from the camera unit 13 into a pixel group of the influenced region A (b) and a pixel group of the uninfluenced region A (a) in the region A, and a pixel group of the influenced region B (a) and a pixel group of the uninfluenced region B (b) in the region B based on the region setting data. In addition, the control device 11 can calculate illuminance in each partial region from a luminance value of pixels in the image data in each partial region based on the region setting data which is stored in the storage unit 11b.

In addition, when calculating illuminance in each of the regions of A and B, a correction may be performed based on a color temperature of the lighting fixture 12 which illuminates each region. In such a case, the control device 11 stores information on the color temperature of each lighting fixture 12 in the storage unit 11b.

In addition, the control device 11 calculates a ratio of an influenced region to the entire region in each region, and stores the ratio in the storage unit 11b. For example, in case of the region A, a value of (area of influenced region A (b)/entire area of region A) is stored in the storage unit 11b as an influenced region ratio value RA in the region A. Similarly, in a case of the region B, a value of (area of influenced region B (a)/entire area of region B) is stored in the storage unit 11b as an influenced region ratio value RB in the region B.

### Operation

Subsequently, a dimming control operation of the control device 11 will be described. The control device 11 performs dimming controls of the plurality of lighting fixtures 12 so that each of the regions A and B has brightness which is set in each region A and B.

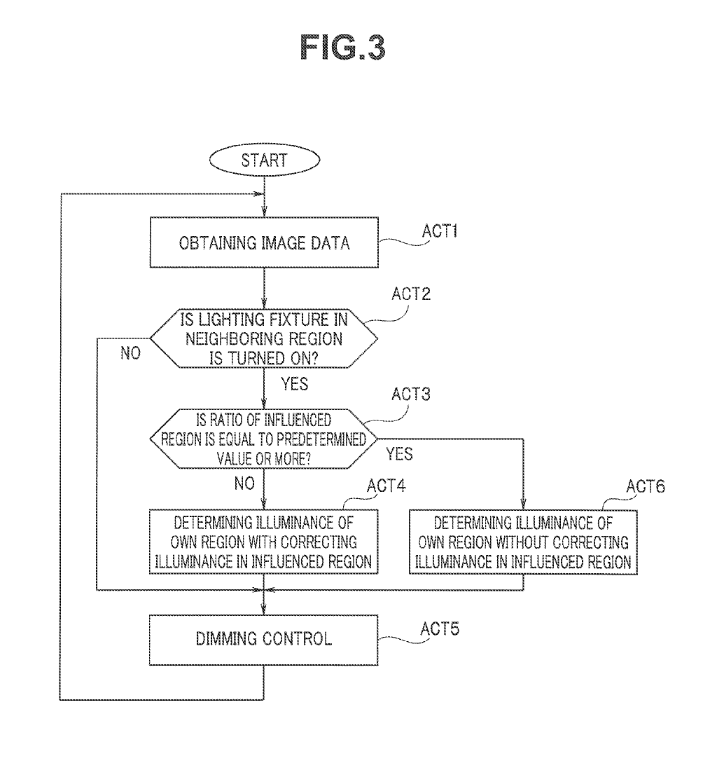

FIG. 3 is a flowchart which illustrates a flow of processing of a dimming control program. The control device 11 performs a dimming control of each lighting fixture 12 so that the two regions A and B have brightness which is respectively set thereto. However, hereinafter, a case in which each of the lighting fixtures 12 is controlled so that the region B has the set brightness will be described. The dimming control program in FIG. 3 is stored in the ROM in the control device 11, and is executed by being read out from the ROM by the CPU 11a.

First, the CPU 11a obtains image data from the camera unit 13 (Act 1). The image data is received through the signal transmission line 14.

In addition, the CPU 11a determines whether or not a lighting fixture 12 in the region A as a region neighboring the region B is turned on (Act 2). Since the control device 11 also controls the brightness in the region A, the control device can determine an ON/OFF state of the lighting fixture 12 which illuminates the region A.

When the lighting fixture 12 in the region A is not turned on (NO in Act 2), the process moves to Act 5.

When the lighting fixture 12 in the region A is turned on (YES in Act 2), the CPU 11a determines whether or not the influenced region ratio value RB which is a ratio of the influenced region B (a) to the region A is a predetermined value Rt or more (Act 3).

When the influenced region ratio value RB is not the predetermined value Rt or more (NO in Act 3), the CPU 11a corrects illuminance L (B (a)) of the influenced region B (a), and determines illuminance of the own region B (Act 4). That is, illuminance L (B) is determined based on illuminance La (B (a)) which is obtained with correction of the illuminance L (B (a)) of the influenced region B (a), and illuminance L (B (b)) of the uninfluenced region B (b).

First, illuminance in each partial region is calculated from a luminance value of a pixel group in the partial region. The CPU 11a calculates the illuminance L (B (a)) which is calculated from a luminance value of a pixel group in the influenced region B (a), and the illuminance L (B (b)) which is calculated from a luminance value of a pixel group in the uninfluenced region B (b), in the region B in the image data. The pixel group in the influenced region B (a) and the pixel group in the uninfluenced region B (b) are extracted based on the above described region setting data.

In addition, the illuminance L (B) in the region B is obtained from the illuminance L (B (a)) in the influenced region B (a) and the illuminance L (B (b)) in the uninfluenced region B (b) in the following manner.

Since the control device 11 also controls the brightness in the region A, and includes information on the ON/OFF state of the lighting fixture 12 which illuminates the region A, and information on a dimming level corresponding to a set value of the brightness in the region A in a case of an ON state, a value of the illuminance L (B (a)) of the influenced region B (a) is corrected according to an ON/OFF state of illumination in the region A and a dimming level. In addition, the control device 11 determines the illuminance L (B) based on illuminance La (B (a)) which is corrected, and the illuminance L (B (b)) in the uninfluenced region B (b). The control device 11, for example, determines the illuminance L (B) by calculating a mean value of the illuminance La (B (a)) and the illuminance L (B (b)).

When one or more lighting fixtures 12 which illuminate the region A are turned on, a value of the illuminance L (B (a)) of the influenced region B (a) is corrected according to a dimming level with respect to the lighting fixture 12 in the region A, and the illuminance L (B) is determined based on the illuminance La (B (a)) as the corrected illuminance, and the illuminance L (B (b)).

For example, the illuminance L (B) is determined based on the illuminance La (B (a)) as the corrected illuminance, and the illuminance L (B (b)) with correction of the illuminance L (B (a)) using a coefficient which is preset according to a dimming level with respect to the lighting fixture 12 in the region A.

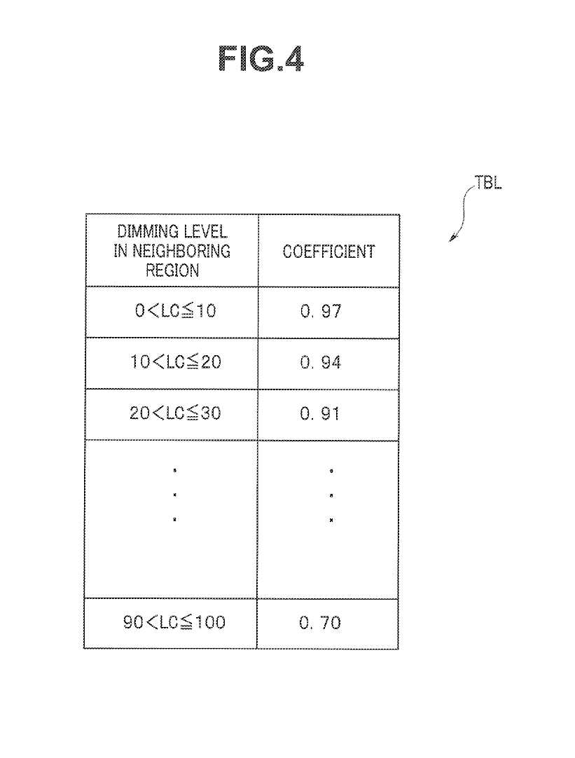

FIG. 4 is a diagram which illustrates an example of a coefficient table TBL for correcting the illuminance L (B (a)) corresponding to the dimming level of the region A as the neighboring region of the region B.

A plurality of coefficients are set according to a dimming level as a dimming state of the region A in the coefficient table TBL in FIG. 4. For example, when a dimming level in the region A is in a range of 0 to 10, a coefficient is 0.97, and a value in which the illuminance L (B (a)) is multiplied by the coefficient 0.97 becomes the illuminance La (B (a)). In addition, when a dimming level of the region A is in a range of 90 to 100, a value in which the illuminance L (B (a)) is multiplied by the coefficient 0.70 becomes the illuminance La (B (a)). The coefficient in the coefficient table TBL is used in this manner.

That is, the illuminance L (B (a)) as a detection value of brightness of the influenced region B (a) is corrected according to a dimming state of the region A (here, dimming level of lighting fixture 12 corresponding to set value of brightness in the region A), and illuminance in the region B is determined based on the illuminance La (B (a)) as the corrected luminance value and the illuminance L (B (b)) as the detection value of brightness of the uninfluenced region B (b).

Accordingly, when the lighting fixture 12 in the region A is turned on, the illuminance L (B) is determined based on the illuminance La (B (a)) as the illuminance which is corrected using weighting according to a dimming state of the lighting fixture 12 in the region A, and the illuminance L (B (b)).

After Act 4, the CPU 11a performs a dimming control of each lighting fixture 12 based on illuminance which is determined in Act 3 (Act 5).

As described above, the CPU 11a of the control device 11 performs a dimming control of the lighting fixture 12 so that brightness in the region B has a set value based on the illuminance La (B (a)) as a detection value which is corrected by performing a correction of the illuminance L (B (a)) as the detection value of brightness of the influenced region B (a) which is influenced by illumination from another lighting fixture in the image data according to a dimming state of another lighting fixture (lighting fixture 12 which illuminates region A) excluding the lighting fixture 12 which illuminates the region B, and the illuminance L (B (b)) as a detection value of brightness of the uninfluenced region B (b) which is not influenced by illuminance from another lighting fixture in the image data.

In addition, when the influenced region ratio value RB is equal to a predetermined value Rt or more (YES in Act 3), the CPU 11a determines illuminance of own region B without correcting the illuminance L (B (a)) of the influenced region B (a) (Act 6), and a dimming control is performed (Act 5). That is, when a ratio of the influenced region B (a) to the entire region B in the image data is larger than the predetermined value Rt, the CPU 11a of the control device 11 performs a dimming control of the lighting fixture 12 so that the illuminance L (B) is determined based on the illuminance L (B (a)) as the detection value of the influenced region B (a) in which a correction is not performed, and the illuminance L (B (b)) as the detection value of the uninfluenced region B (b), and the brightness of the region B becomes a set value.

This is because the entire region B easily obtains the set brightness when the illuminance L (B) of the region B is determined without subtracting an influencing amount of the lighting fixture 12 in the region A, since the influenced region ratio value RB in the region B is large in a case of YES in Act 3.

After Act 6, the CPU 11a performs a dimming control of each lighting fixture 12 based on the illuminance which is determined in Act 4 (Act 5).

In addition, the illuminance L (B (a)) as the detection value of the influenced region B (a) and the illuminance L (B (b)) as the detection value of the uninfluenced region B (b) may be respectively corrected according to color temperatures of a lighting fixture 12 in the region B and a lighting fixture in the region A.

After Act 5, the process returns to Act 1.

In addition, in the above described example, in Act 2, whether or not a lighting fixture in the neighboring region is turned on is determined, and illuminance in the influenced region is corrected when the lighting fixture is turned on; however, in Act 4, a correction amount may be determined by determining whether or not a lighting fixture in the neighboring region is turned on when correcting illuminance in the influenced region, without performing a process in Act 2.

Specifically, in a case of the above described example, when one or more lighting fixtures 12 for illuminating the region A are turned off, a value of the illuminance L (B (a)) of the influenced region B (a) is corrected using weighting for the correction of 0 (zero), and the illuminance L (B) of the region B is determined based on the illuminance L (B (a)) of which the correction amount is 0, and the illuminance L (B (b)).

That is, in Act 4, the illuminance in region B may be determined, with correcting of the illuminance L (B (a)) as the detection value of brightness of the influenced region B (a) according to a dimming state including an ON/OFF state of the lighting fixture 12 in the region A and a dimming level, based on the illuminance La (B (a)) as the corrected luminance value, and the illuminance L (B (b)) as the detection value of brightness of the uninfluenced region B (b).

The process in FIG. 3 is also executed so that the region A is controlled to have the set brightness.

Accordingly, even when each region is a region in which illumination light from a neighboring region is input, brightness in each region can be appropriately controlled so that brightness in each region becomes the set brightness in consideration of an influence of illumination light in the neighboring region.

In addition, as illustrated in FIG. 2, in the above described example, the influenced region is one; however, a plurality of influenced regions may be set since illuminance is changed according to a distance to which illumination light reaches. In addition, the above described coefficients are set so as to be different from each other in the plurality of influenced regions.

The above described example is a case of including a region in which one of two regions is influenced by illumination of the other; however, even in a case of including a region in which one region is influenced by illumination of other regions of two or more in regions of three or more, the same is applied thereto. For example, even in a grid lighting system, the same is applied thereto.

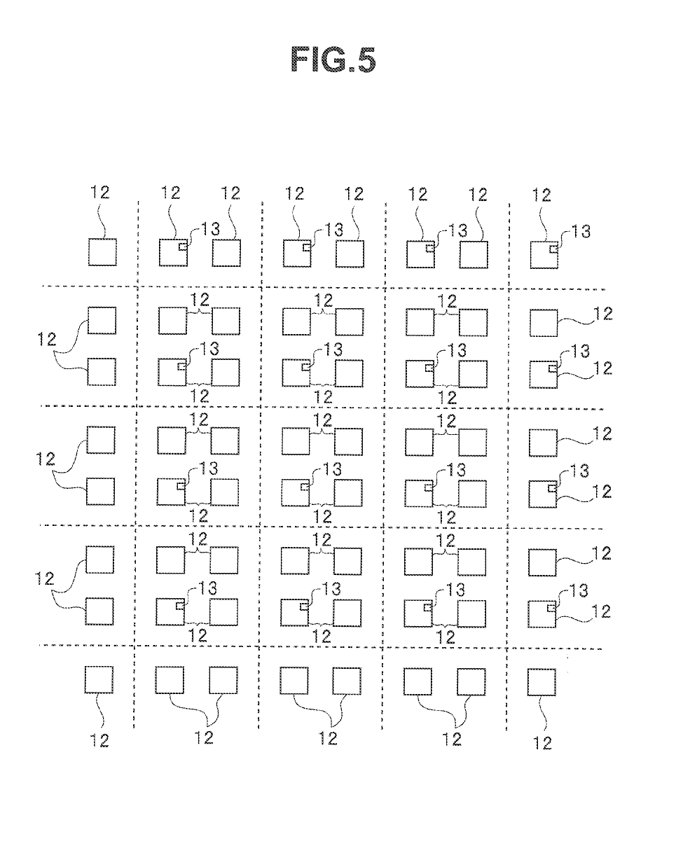

FIG. 5 is a diagram which illustrates a configuration of a grid lighting system. FIG. 5 is a plan view which illustrates a state in which a plurality of grid lighting fixtures for a ceiling (hereinafter, referred to as grid lighting fixture) are provided on a ceiling of a grid-type system.

As illustrated in FIG. 5, the plurality of grid lighting fixtures 12 are arranged in a grid shape on a ceiling in a room. Here, the control device 11 performs a dimming control of each grid lighting fixture 12 so that each region which is surrounded with a dotted line has set brightness.

Each region is illuminated by four grid lighting fixtures 12. The camera unit 13 is provided at one of the four grid lighting fixtures 12. The camera unit 13 in each region transmits image data including an image of own region to the control device 11 through the signal transmission line 14.

The influenced region which is influenced by illumination due to a lighting fixture which illuminates a neighboring illumination region, and the uninfluenced region which is not influenced by illumination due to a lighting fixture which illuminates a neighboring illumination region in each illumination region are preset with respect to each region of the image data. In a case of the grid lighting system, each region includes influenced regions of 4 to 8 due to illumination of neighboring regions of 4 at maximum, or of 8. In addition, the camera unit 13 in each region may be an area sensor which also has a function as a human sensor, having not only the function as an area sensor which obtains image data for obtaining illuminance.

In addition, region setting data which denotes a range of a plurality of influenced regions and one uninfluenced region in the image data in each region is preset, and is stored in the storage unit 11b. Accordingly, the control device 11 can extract image data in each partial region from image data in each region based on region setting data with respect to each region.

Accordingly, illuminance in each region is determined from illuminance of a plurality of influenced regions and illuminance of one uninfluenced region in the image data in each region, and the control device 11 performs a dimming control of the plurality of grid lighting fixture 12 so that each region has set brightness of own.

As described above, according to the lighting control system of the embodiment, it is possible to control a region including a region to which illumination light illuminating a neighboring region is input so as to have set brightness.

In addition, a part, or all of the programs which execute the above described operation are recorded, or stored in a portable medium such as a flexible disk, or a CD-ROM, or a storage medium such as a hard disk as a computer program product. The program is read out by a computer, and all, or a part of the operations is executed. Alternatively, it is possible to distribute or provide all, or a part of the program through a communication network. A user is able to easily execute the lighting control system and the lighting control method according to the embodiment by installing the program to a computer by downloading the program through a communication network, or by installing the program to a computer from a recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting control system comprising:
a data output unit which outputs data including information on brightness in a region to be illuminated by a lighting fixture; and
a control device which performs a dimming control of the lighting fixture so that brightness in the region becomes a set value based on a corrected first detection value obtained by performing a correction of a first detection value of brightness in an influenced region which is influenced by illumination from another lighting fixture in the region according to a dimming state of the other lighting fixture than the lighting fixture, and a second detection value of brightness in an uninfluenced region which is not influenced by illumination from the other lighting fixture in the data.

2. The system according to claim 1,
wherein the correction is performed using weighting corresponding to the dimming state of the other lighting fixture.

3. The system according to claim 1,
wherein the dimming state is a dimming level of the other lighting fixture.

4. The system according to claim 1,
wherein the data is image data of an area sensor,
region setting data for setting the influenced region and the uninfluenced region in the image data is preset, and
the control device extracts the influenced region and the uninfluenced region from the image data based on the region setting data.

5. The system according to claim 1,
wherein the control device performs a dimming control of the lighting fixture so that brightness in the region becomes a set value using the first detection value which is not subject to the correction, and the second detection value when a ratio of the influenced region to the region in the data is larger than a predetermined value.

6. The system according to claim 1,
wherein the first detection value and the second detection value are detection values which are corrected according to color temperatures of the lighting fixture and the other lighting fixture, respectively.

7. The system according to claim 1,
wherein the data is image data of an area sensor,
region setting data for setting the influenced region and the uninfluenced region in the image data is preset, and
the control device extracts the influenced region and the uninfluenced region from the image data based on the region setting data, and performs a dimming control of the lighting fixture so that brightness in the region becomes a set value using the first detection value which is not subject to the correction, and the second detection value when a ratio of the influenced region to the region in the image data is larger than a predetermined value.

8. The system according to claim 7,
wherein the first detection value and the second detection value are detection values which are corrected according to color temperatures of the lighting fixture and the other lighting fixture, respectively.

9. A lighting control system comprising:
a plurality of lighting fixtures;
a data output unit which outputs data including information on brightness with respect to a region which is illuminated by one lighting fixture among the plurality of lighting fixtures; and
a control device which is connected to the plurality of lighting fixtures and the data output unit through a signal transmission line, and performs a dimming control of the one lighting fixture so that brightness in the region becomes a set value based on a corrected first detection value obtained by performing a correction of a first detection value of brightness in an influenced region which is influenced by illumination from the other lighting fixture in the region according to a dimming state of the other lighting fixture than the one lighting fixture, and a second detection value of brightness of an uninfluenced region which is not influenced by illumination from the other lighting fixture in the data.

10. The system according to claim 9,
wherein the correction is performed using weighting corresponding to a dimming level as the dimming state of the other lighting fixture.

11. The system according to claim 9,
wherein the data is image data of an area sensor,
region setting data for setting the influenced region and the uninfluenced region in the image data is preset, and
the control device extracts the influenced region and the uninfluenced region from the image data based on the region setting data, and performs a dimming control of the one lighting fixture so that brightness in the region becomes a set value using the first detection value which is not subject to the correction, and the second detection value when a ratio of the influenced region to the region in the image data is larger than a predetermined value.

12. The system according to claim 9,
wherein each of the plurality of lighting fixtures are grid lighting fixtures.

13. A lighting control method comprising:
obtaining information on brightness with respect to a region which is illuminated by a lighting fixture; and
performing a dimming control of the lighting fixture so that brightness in a region becomes a set value based on a corrected first detection value obtained by performing a correction of a first detection value of brightness of an influenced region which is influenced by illumination from another lighting fixture in data, according to a dimming state of the other lighting fixture than the lighting fixture, and a second detection value of brightness of an uninfluenced region which is not influenced by illumination from the other lighting fixture in the data.

14. The method according to claim 13,
wherein the correction is performed using weighting corresponding to the dimming state of the other lighting fixture.

15. The method according to claim 13,
wherein the dimming state is a dimming level of the other lighting fixture.

16. The method according to claim 13,
wherein the data is image data of an area sensor,
region setting data for setting the influenced region and the uninfluenced region in the image data is preset, and
the influenced region and the uninfluenced region are extracted from the image data based on the region setting data.

17. The method according to claim 13,
wherein, when a ratio of the influenced region to the region in the data is larger than a predetermined value, the lighting fixture is subject to a dimming control so that brightness in the region becomes a set value using the first detection value which is not subject to the correction, and the second detection value.

18. The method according to claim 13,
wherein the first detection value and the second detection value are detection values which are corrected according to color temperatures of the lighting fixture and the other lighting fixture, respectively.

19. The method according to claim 13,
wherein the data is image data of an area sensor,
region setting data for setting the influenced region and the uninfluenced region in the image data is preset, and
the control device extracts the influenced region and the uninfluenced region from the image data based on the region setting data, and performs a dimming control of the lighting fixture so that brightness in the region becomes a set value using the first detection value which is not subject to the correction, and the second detection value when a ratio of the influenced region to the region in the image data is larger than a predetermined value.

20. The method according to claim 19,
wherein the first detection value and the second detection value are detection values which are corrected according to color temperatures of the lighting fixture and the other lighting fixture, respectively.
